(19) United States
(12) Patent Application Publication
(10) Pub. No.: US 2002/0046033 A1
(43) Pub. Date: Apr. 18, 2002

(54) Voice recognition operation system and method for operating the same

(75) Inventors: Takeshi Ono, Tokyo (JP); Okihiko Nakayama, Kanagawa-ken (JP); Norimasa Kishi, Kanagawa-ken (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 09/973,038

(22) Filed: Oct. 10, 2001

(30) Foreign Application Priority Data
Oct. 12, 2000 (JP) P2000-312076

(51) Int. Cl. G10L 21/00; G10L 11/00

(52) U.S. Cl. 704/270

(57) ABSTRACT

A voice recognition operation system and a method for operating the same are disclosed wherein a verbal input is compared with a recognition word set stored in a memory 8 which stores correlated interactive operational patterns to select a pertinent recognition word set and interactive operational pattern, with the selected data being displayed over a speaker 5 and a display 3. A new mode recognition mode setting device 7 enables setting of a new registering mode in which an input section 1, 2, 7 enables inputting of various information into the memory 8, and a setting section 9 enables setting of a new recognition word set and an interactive operational pattern, to be used for new voice recognition operational purpose, on the basis of various information in the presence of the new registering mode. A registering section 9 registers the preset resultant data in the memory 8.

### BACKGROUND OF THE INVENTION

The present invention relates to voice recognition systems and, more particularly, to a voice recognition operation system and a method for operating the same for recognizing uttered word command to operate various equipments.

It has heretofore been proposed to use a voice recognition operation system wherein uttered word is compared with a word (hereinafter referred to as a registered word) which is preliminarily stored in a memory and an interactive operational pattern allocated to the registered word which matches the uttered word, a typical example of which is disclosed in Japanese Patent Provisional Publication No. 11-351901.

### SUMMARY OF THE INVENTION

However, in such a voice recognition operation system, it is hardly to know what kind of words are preliminarly stored in the memory device or what kind of interactive operational patterns are allocated to the stored wards. Thus, it becomes difficult to properly recognize what kind of recognition word set to be uttered and the user hardly manages the voice recognition operation system, with a resultant inconvenience and increased time loss in operation.

To improve such an inconvenience, even when a plurality of word commands are allocated to a single operational pattern, the amount of data for the registered words remarkably increases, requiring inordinate amount of time and effort to manipulate to system to conduct a search for a particular registered recognition word set that matches the uttered word with a poor operability caused in the system.

The present invention has been in view of the above and has an object of the present invention to provide a voice recognition operation system and a method for operating the same which provides highly efficient operation and an improved operability.

According to a first aspect of the present invention, there is provided voice recognition operation system, which comprises a verbal input providing section providing a verbal input, a memory storing a number of recognition word sets and interactive operational patterns to be used for voice recognition operational purposes, a searching section searching a recognition word set, which has the highest matching degree with the verbal input, from the memory, an output providing section providing an output of interactive operation patterns correlated with the searched recognition word set, a new registration mode setting device setting a new registering mode to allow a particular recognition word set to be newly registered in the memory for use in another interactive operational pattern, an input device inputting various information to the memory, a setting section setting the newly registered recognition word set and interactive operational pattern on the basis of information inputted by the input device in the presence of the new registering mode, and a registering section registering resultant data, obtained by the setting section, in the memory.

According to a second aspect of the present invention, there is provided a voice recognition operation system, which comprises means providing a verbal input, means storing a number of recognition word sets and interactive operational patterns to be used for voice recognition operational purposes, means searching a recognition word set, which has the highest matching degree with the verbal input, from the storing means, means providing an output of interactive operation patterns correlated with the searched recognition word set, means setting a new registering mode to allow a particular recognition word set to be newly registered in the storing means for use in another interactive operational pattern, means inputting various information to the storing means, means setting the newly registered recognition word set and interactive operational pattern on the basis of information inputted by the inputting means in the presence of the new registering mode, and means registering resultant data, obtained by the setting means, in the storing means.

According to a third aspect of the present invention, there is provided a method for operating a voice recognition operation system, which comprises providing a verbal input, storing a number of recognition word sets and interactive operational patterns, to be used for voice recognition operational purposes, in a memory, searching a recognition word set, which has the highest matching degree with the verbal input, from the memory, providing an output of interactive operation patterns correlated with the searched recognition word set, setting a new registering mode to allow a particular recognition word set to be newly registered in the memory for use in another interactive operational pattern, inputting various information to the memory, setting the newly registered recognition word set and interactive operational pattern on the basis of information inputted by the inputting step in the presence of the new registering mode, and registering resultant data, obtained in the setting step, in the memory.

### BRIEF DESCRIPTION OF THE DRAWINGS

The invention, together with objects and advantages thereof, may best be understood by reference to the following description of the presently preferred embodiments together with the accompanying drawings, in which:

FIG. 1 is a block diagram of a voice recognition operation system of a first preferred embodiment according to the present invention;

FIG. 2 is a general flow diagram for illustrating various process steps to achieve registration of recognition word sets to be used for voice recognition operation system shown in FIG. 1;

FIG. 3 is a table for illustrating an example of verbal communication between a user and a server computer of a base station;

FIG. 4 is a table for illustrating recognition message words in terms of interactive operational patterns;

FIG. 5 is an example of a screen of a display providing a display of recognition message words;

FIG. 6 is a general flow diagram various process steps to execute interactive operation with the voice recognition operation system shown in FIG. 1;

FIG. 7 is a schematic view for illustrating a plurality of icons that belong to a message category “News”;

FIG. 8 is a table for illustrating an example of verbal communication between the user and the server computer of the base station;

FIG. 9 is a table for illustrating recognition message words, associated icons and interactive operational patterns;

FIG. 10 is an example of a screen of a display illustrating the recognition message words and the associated icons;

FIG. 11 is a schematic view illustrating the base station to be operated by an operator;

FIG. 12 is a block diagram of a voice recognition operation system of a second preferred embodiment according to the present invention; and

FIG. 13 is a general flow diagram for illustrating the basic sequence of a process to execute registration of the recognition word sets to be used for voice recognition operational purposes.

### DETAILED DESCRIPTION OF THE PREFERRED EMBODIMENTS

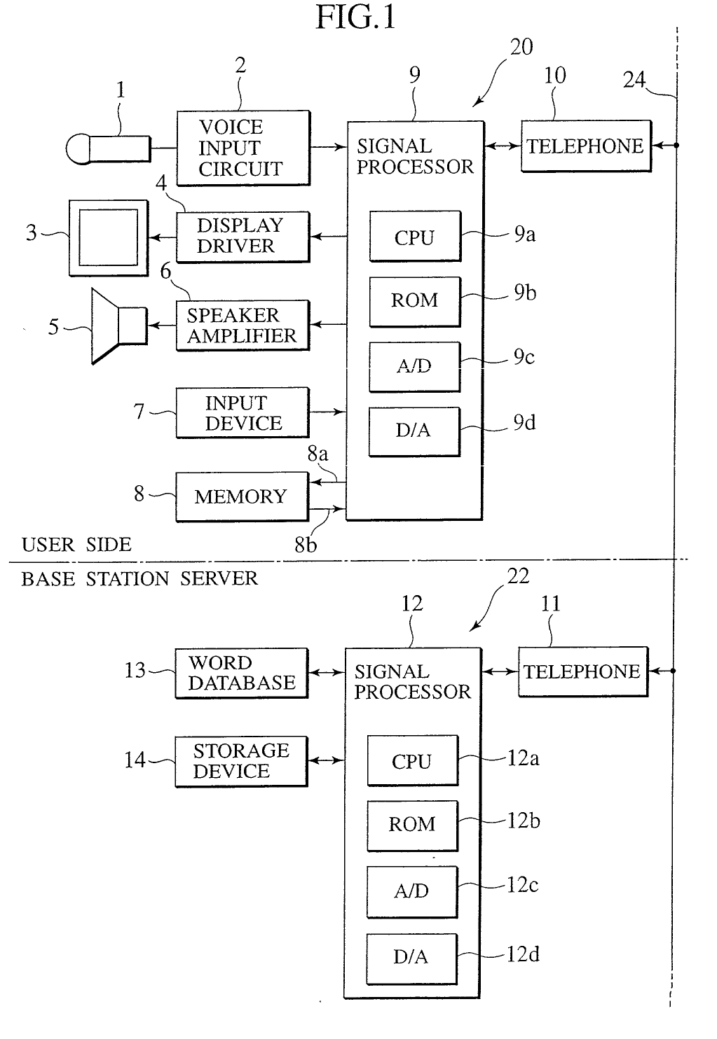

Before entering into a detailed description of a voice recognition operation system of the present invention, note should be undertaken here that the voice recognition operation system is herein described with reference to an exemplary case wherein the voice recognition operation system has a remote or server computer (hereinafter collectively called “server”) and a local or client computer (hereinafter collectively called “client”) which are connected together through a network, such as the Internet, to allow the server computer to provide a display of the client computer various information such as news or weather forecast purposes, though not intended to limit the present invention. For example, information to be provided to the client's display monitor may involve on line shopping catalog information, music information or game software, etc. Since all client and server computers will have, for the purposes of the present invention, the same properties, for simplicity of illustration and description, FIG. 1 and the following description illustrate and describe, respectively, the interaction between the single local (client) computer and the single remote (server) computer.

### FISRT PREFERRED EMBODIMENT

Referring not to FIG. 1, there is shown a voice recognition operation system of a first preferred embodiment according to the present invention. The voice recognition operation system includes a client computer 20 located at a user side and a server computer 22 located at a remote base station.

The client computer 20 is a general purpose computer, such as an existing personal computer. The client computer 20 is applied with a verbal input providing section composed of a microphone 1 for collecting an uttered voice, and a voice input circuit 2 which converts the uttered voice into the verbal input to be applied to a signal processor 9.

The signal processor 9 generates a display signal which is applied through a display driver 4 to provide a display of pre-synthesized recognition word sets and message word sets etc. over the display 3. The signal processor 9 is further connected through a speaker amplifier 6 to a speaker 5 to broadcast an verbal output of confirmatory response word sets and pre-synthesized word sets, and message words sets. An input device 7 includes various switch components not specifically shown in FIG. 1, such as a manual mode selection switch for enabling setting of a new registering mode to enable the signal processor 9 to set a new word set and an interactive operational pattern to be used for new voice recognition operational pattern. A memory 8 has a recognition word dictionary including a number of recognition word sets stored at a corresponding number of recognition word set addresses in the memory 8, and a number of interactive operational patterns stored at corresponding number of operational pattern addresses in the memory 8. The signal processor 9 includes a central processing unit (CPU) 9a, a Read-On-Memory (ROM) 9b that stores various software programs to achieve various operating functions as will be discussed later, an A/D converter 9c and a D/A converter 9d for executing voice recognition and updating record or registration of new word. The A/D converter 9c converts the electrical voice signal delivered from the voice input circuit 2 into a digital voice signal, and the D/A converter 9d converts the digital voice signal into an analog voice signal which is applied through the speaker amplifier 6 to the speaker 5.

The signal processor 9 electrically communicates with the memory 8 by producing address signals which are transmitted to the memory 8 over a plurality of address lines 8a. The appropriate word set data, pre-synthesized phrases, and associated icons are preferably communicated between the signal processor 9 and the memory 8 over a plurality of data lines 8b.

An important feature of the voice recognition operation system of the present invention concerns the signal processor 9 serving as various operating section including: a searching section to execute a search for a recognition word set, having the highest word matching degree with the recognition word set corresponding to the uttered word in the form of the verbal input; among the number of recognition word sets stored in the memory 8; an output providing section to provide an output of an interactive operational patterns, stored in the memory 8, correlated with the recognition word set searched by the searching section; a new recognition word set setting section to allow a new recognition word set and an interactive operational pattern to be newly set on the basis of information inputted through the input device 1, 2, 7 in the presence of a new recognition mode set by the input device; and a registering section to allow data, newly set by the setting section, to be registered in the memory 8.

As noted above, the client computer 20 and the server computer 22 are connected to, and in communication with, each other through a disconnected network 24 via telephones 10, 11. To this end, the server computer 22 includes a signal processor 12.

In the server computer 22 located at the remote base station, the signal processor 12 includes a central processor unit (CPU) 12a, a Read-On-Memory (ROM) 12b, an A/D converter 12c and a D/C converter 12d for communicating with the signal processor 9 of the client computer 20 and performing transfer of various information. The signal processor 12 of the server computer 22 includes a word database 13 which stores therein a number of predetermined word information to be used for voice recognition control or communication with a user of the client computer 20, and a storage device 14 which stores general information such as news, weather forecast and stock prices, etc. The database may be located in the server computer 22 itself, or may be located remotely on a database server (not shown).

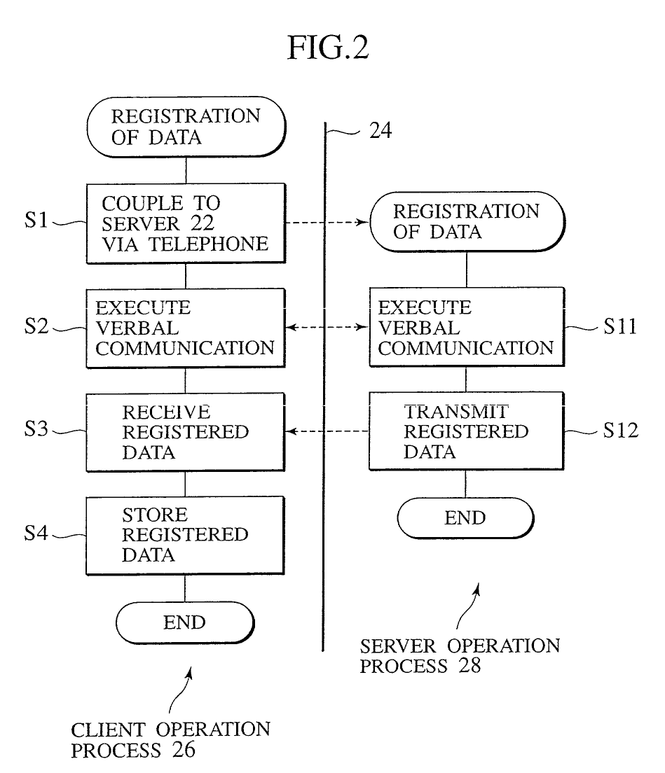

FIG. 2 is a general flow diagram illustrating various process steps to achieve registration of word sets in the voice recognition operation system of the present invention, i.e., in a client operation process 26 and in a server operation process 28 for registering new recognition word sets to be used for voice recognition operation purposes and interactive operational patterns. The client operation process 26 involves a process step for executing registration of the new recognition word sets in the client computer 20, and the server process 28 involves a process step for executing registration in the server computer 22.

The memory 8 of the client computer 20 preliminarily stores standard recognition word sets to be used for voice recognition and interactive operational patterns correlated with the standard recognition word sets to be executed for required equipments. The user is able to execute registration by replacing (updating) the pre-registered standard word sets with new commonly used word set, or to newly add another new word set and its associated voice recognition operational pattern for a newly required function. Of course, particular recognition word sets for use in voice recognition operation and correlated particular operational pattern for a particular function may be originally and arbitrarily registered by the user himself.

When a new registration mode is set by the user using the input device 7 of the client computer 20, the signal processor 9 commences the client operation process 26 shown in FIG. 2 to execute registration of data. In step S1, the signal processor 9 of the client computer 20 is coupled to a local channel, which executes registration of data in the server operation process 28, of the signal processor 12 of the server computer 22 via the telephones 10, 11. Upon receiving a request signal from the client computer 20 in step S1, the server computer 22 starts to perform registration in the server process 28. In the next steps S2, S11, verbal communication is carried out between the user of the client computer 20 and the server computer 22. More specifically, the uttered voice collected by the microphone 1 is transmitted through the voice input circuit 2 and the signal processor 9 to the signal processor 12 of the server computer 22 via the telephones 10, 11. On one hand, the server computer 22 generates a pre-synthesized confirmatory message word set and related image information, which are delivered to the signal processor 9 of the client computer via the telephones 10, 11. Then, the verbal output of the message word set is broadcasted over the speaker 5 for user's confirmation purposes. Also, image information is delivered through the display driver 4 to the display 3 to provide a display of interacting image information for user's confirmation purposes.

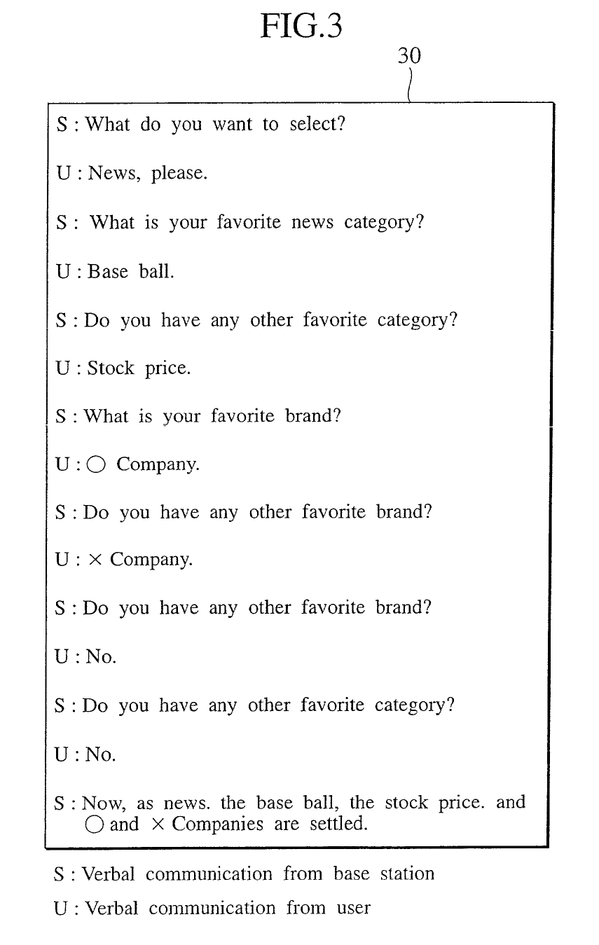

FIG. 3 shows an example of a summary table 30 having a number of pre-synthesized message word sets expressed in a query form for verbal communication to be executed between the user and the server computer 22. This example shows how process steps carried out for registering a new recognition word set “News”, to be newly used in voice recognition operation, and corresponding operational patterns with respect to a function to retrieve and display “Base Ball Information and Stock Price Information of O Company and X Company”. Such a verbal communicating function is clearly disclosed in a literature entitled “Study For Constructing Robust Communication System” issued by Information Processing Institute and Acoustic Language Data Processing Society and numbered as 94-SLP-7-22 (1995), or in a literature entitled “Cooperative Response In Verbal Communication System” issued by Human Interface Study Report and numbered as 96-SLP-10-19 (1996, 3) and, hence, a detailed description of the same is herein omitted for the sake of simplicity.

The word database 13 stores a large scale word dictionary containing a large number of registered standard recognition word sets, to be used for executing verbal communication, for allowing the user to use arbitrary words, which are daily used and accustomed, such as “Today's Event” in place of the word “News”.

When completing the verbal communication between the user and the server computer 22 via the client computer 20, the signal processor 12 of the server computer 22 transmits registered data, including the stored recognition word sets, which are newly registered in step S12, and registered interactive operational functions to be carried out in a required equipment in compliance with the stored recognition word sets, to the signal processor 9 of the client computer 20 via the network composed of the telephones 10, 11. In step S3, the signal processor 9 of the client computer 20 receives the registered data from the server computer 22 and sends the image output signal to the display 3 via the display driver 4. In the next step S4, registered data is stored in the memory 8, thereby completing the registration mode in the client operation process 26.

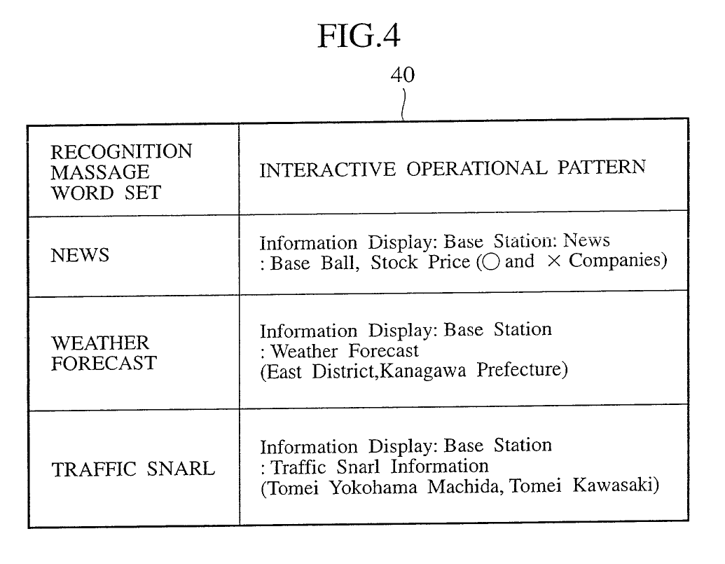

FIG. 4 shows a summary table 40 illustrating an example of stored data containing the relationship between the newly registered recognition message word sets to be used for voice recognition operation and the associated operational patterns to be carried out in equipments corresponding to the respective newly registered recognition message words.

In this example, in addition to the message word set “News” and corresponding operational function, the registered recognition message words sets further involve another new message word “Weather Forecast” and correlated operational function to retrieve and display weather forecast data in the vicinity of a particular area “East District in Kanagawa Prefecture” and still another message word “Traffic Snarl” and correlated operational function to retrieve and display traffic snarl information in the vicinity of a particular area “Tomei Yokohama Machida ad Tomei Kawasaki”.

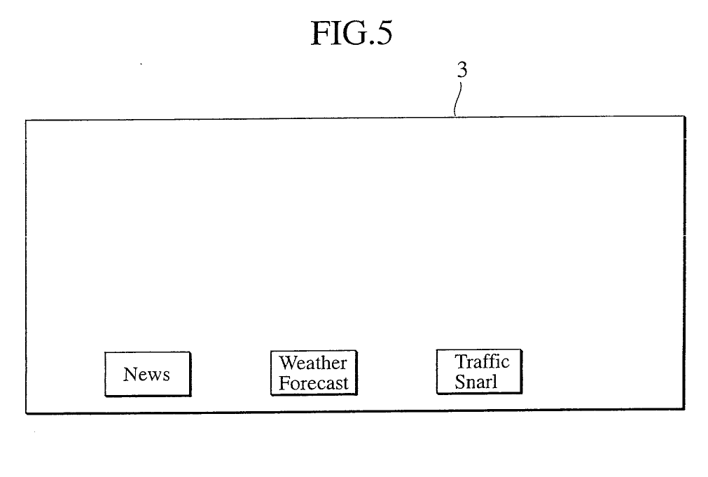

FIG. 5 shows an example of a display pattern of the display 3 wherein the newly registered recognition message words “News”, “Weather Forecast” and “Traffic Snarl” are displayed at a lower portion of the display 3

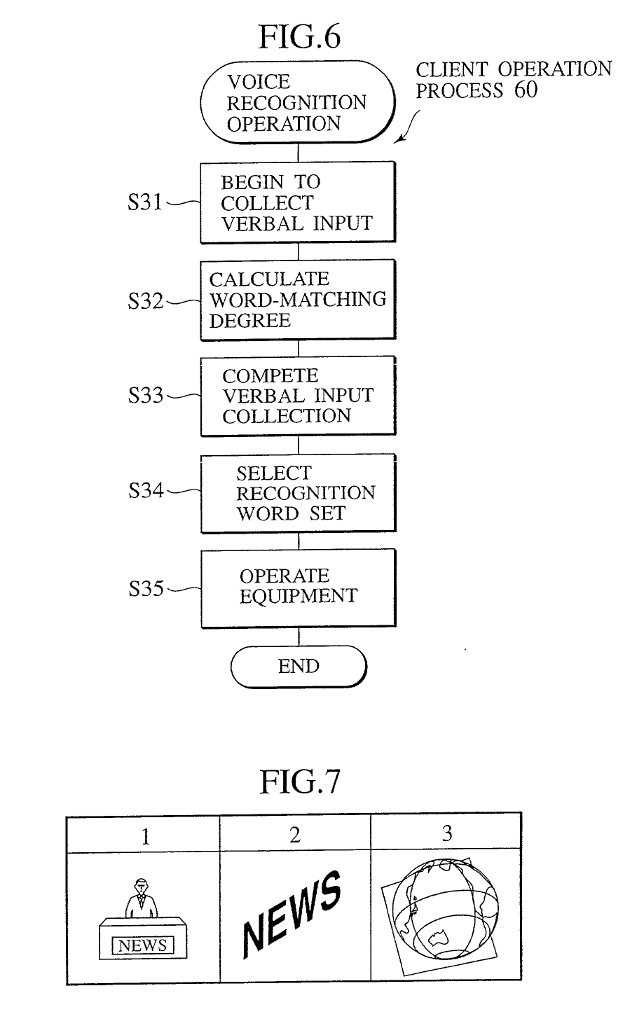

FIG. 6 is a general flow diagram for illustrating a client operation process 60 for voice recognition steps to be executed by the user at a terminal side. When the voice recognition operation start switch (not shown) of the input device 7 is actuated, the signal processor 9 of the client computer 20 responds to send a verbal output through the speaker amplifier 6 to the speaker 5 to produce a verbal output indicative of the start of the voice recognition process, beginning the client operation process 60. In the execution of step S31, power of the verbal input is compared with a reference power level, and when power of the verbal input exceeds an average reference power level by a given value among those of previously accumulated verbal inputs, it is recognized that a voice command is uttered by the user. Once the uttered word is recognized, supply of the verbal input begins to be inputted to the signal processor 9 from the verbal input providing section. In a consecutive step S32, while maintaining the supply of the verbal input to the signal processor 9, a contiguous segment of the verbal input is extracted as a single word, which is calculated by referring the word dictionary to find the degree of word matching relative to the corresponding recognition word set stored in the memory 8. In step S33, when power of the verbal input delivered by the verbal input providing section 2 remains in a value below the given power level for more than a predefined time interval, then, it is recognized that the voice command is no more uttered by the user. When this occurs, sound collection of the microphone 1 is ended.

In step S34, the signal processor 9 selects the recognition word set from the word dictionary, which is stored in the memory 8, with the highest degree of word matching with the word uttered by the user, and the selected recognition word set is treated as a recognition word set. When searching for the stored recognition word set registered in the memory 8, the stored recognition word set, which have been newly registered in the aforementioned in the client operation process 26, have a higher priority in search than those which have been previously registered as basic or standard recognition word sets in the memory 8. Since it is a usual practice for the user to register the recognition word sets which are commonly used, it is possible for the client computer 20 to execute search for the targeted recognition word set which is matched with the word command uttered by the user during voice recognition operation in a more rapid and precise manner, with a resultant increase in the response time and reliability in voice recognition operation.

Then, the appropriate recognition word set is converted to a voice message using voice synthesizing data which is stored in the memory 8, and the voice message is further converted to an analog voice signal by the D/A converter 9d of the signal processor 9 to allow the speaker 5 to produce a voice message to broadcast a confirmatory voice message over the speaker 5 for confirmation and validation purposes. When this occurs, it is possible for the user to confirm whether or not the uttered voice command is correctly recognized in the signal processor 9. In consecutive step S35, the signal processor 9 reads out the content of the voice recognition operation correlated with the recognized word set, thereby implementing a required operation in the particular equipment.

For example, if the word uttered by the user is “News”, the uttered word “News”, which is converted into a digital voice signal, is sequentially referred to the pre-registered word in the memory 8 to calculate the degree of word matching. The registered word, which has the highest degree of word matching with the uttered word “News”, is recognized as “News”, which is then converted to the analog voice signal by which the speaker 5 produces the corresponding verbal input. Concurrently, the signal processor 9 of the client computer 20 responds to the recognized word “News” to retrieve a particular operating pattern to cause “Base Ball” information and “Stock Price Information for the O Company and the X Company” to be retrieved from the base station for display. In accordance with the particular operation pattern read out, the telephone 10 is coupled through the telephone 11 to a specific channel of the signal processor 12 of the server computer 22 at the base station for obtaining particular information such that news related with “Base Ball” information and “Information of Stock Price for O Company and X Company” are retrieved and displayed via the display monitor 3 in a sequential manner.

As noted above, when the mode for newly registering the particular recognition word set to be used for particular voice recognition operation is selected by the manual switch of the input device 7, the particular recognition word set is allocated to the particular operational pattern which in turn is registered in the memory 8. With such an allocation, it is possible for the recognition word set, which is commonly used by the user, to be used for the voice recognition operation, enabling the uttered word to be quickly and correctly recognized to provide an improved response and reliability in voice recognition operation.

Further, the voice recognition operation is arranged to interconnect the client computer and the server computer via the network to enable access of the word database of the server computer to store therein the recognition word set and the associated voice recognition operational patterns. With such an arrangement, even in the absence of a large scale word database, it is possible for the user to use arbitrary recognition word sets, which are commonly used by the user, for voice recognition operational purposes and to preset particular voice recognition operational pattern in a quick and easy manner.

Further still, since the voice recognition operation system is arranged to allow a newly registered word, for use in voice recognition control, to be displayed on the display monitor 3, it becomes possible for the use to visually confirm the registered recognition word set for thereby avoiding erroneous registration of the word.

### MODIFIED FORM OF FIRST PREFERRED EMBODIMENT

The voice recognition operation system of the first preferred embodiment is modified such that the client computer is arranged so as to display the word, which is newly registered for the particular voice recognition operation, with icon.

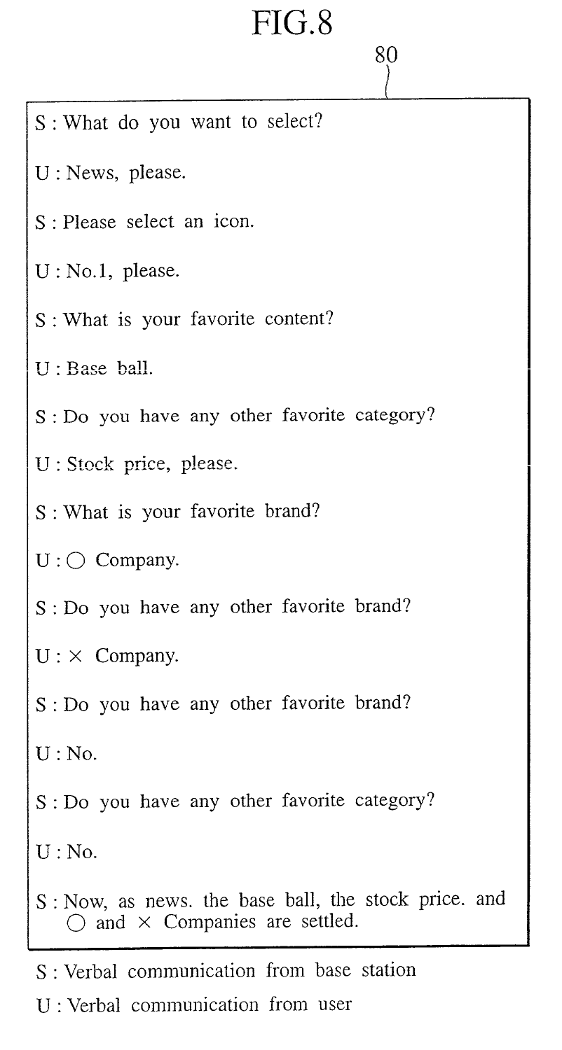

In particular, the word database 13 of the server computer 22 stores icons correlated with the registered recognition word sets to be used for the respective voice recognition operational patterns. In the verbal communication between the client computer 20 shown in FIG. 2 and the server computer 22 located at the base station, the signal processor 12 of the server computer 22 reads out icon information identified for “News” from the word database 13 and delivers selected icon image pictures, shown in FIG. 7, to the client computer 20 for display over the display 3 to call user's attention for selecting a particular icon related to “News” information in a query pattern 80 shown in FIG. 8. The icon pictures are transmitted through the signal processor 9 of the client computer 20 and displayed on the display 3, and the user selects either one of the icons of “News” menus to reply its number.

The signal processor 12 of the server computer 22 transmits the newly registered recognition message word “News” and correlated icon and voice recognition operational pattern to the signal processor 9 of the client computer 20. The signal processor 9 of the client computer 20 receives registered data transmitted from the server computer 22 to display the registered data over the display 3 and to store the same in the memory 8.

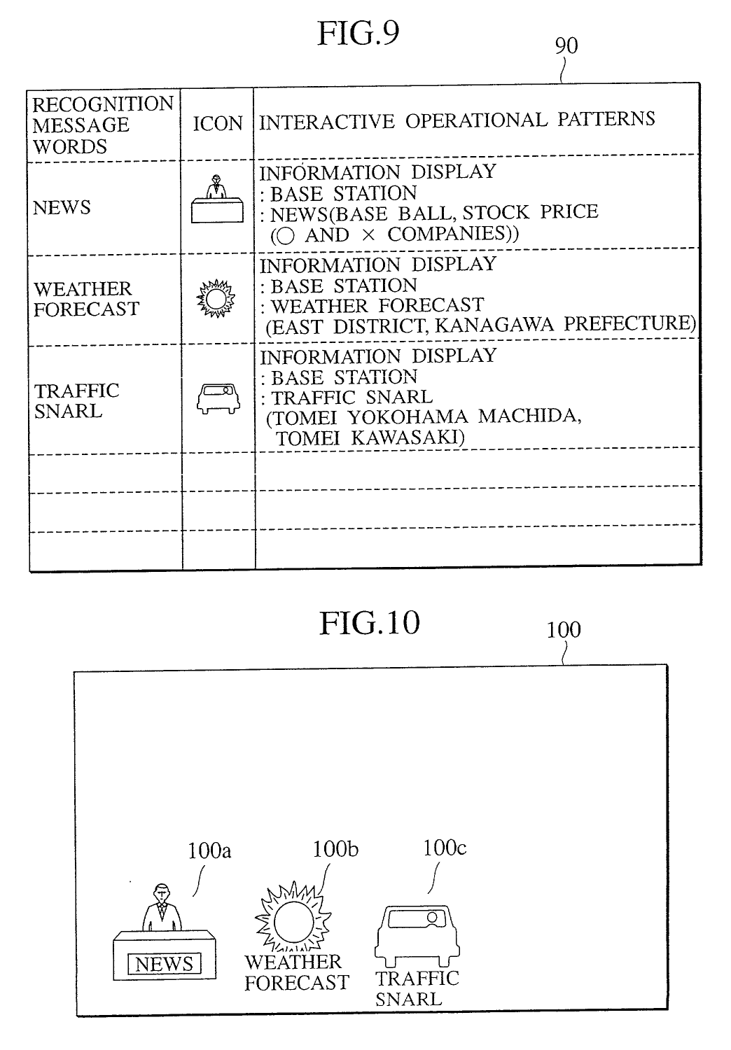

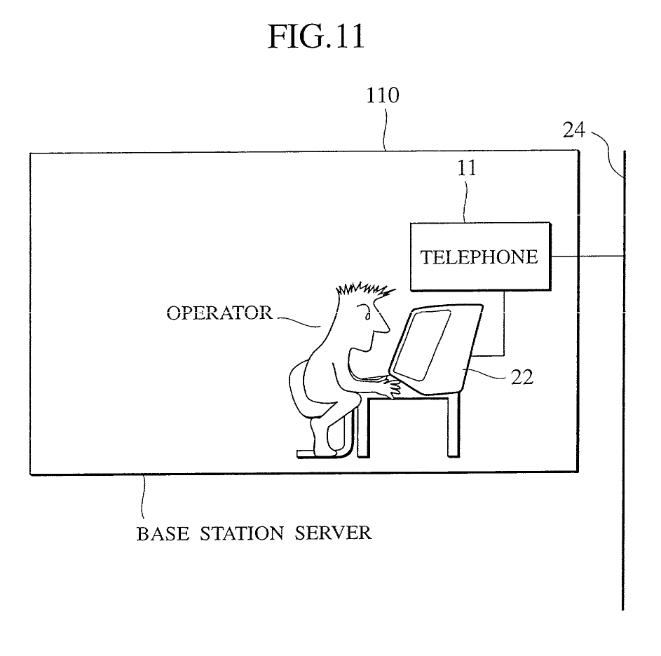

FIG. 9 shows a table 90 for illustrating the relationship among the registered recognition word sets, the icons and the interactive operational patterns. In the table 90, data involves, in addition to the registered recognition message word “News”, its icon and associated operational pattern, the new registered message world “Weather Forecast”, its icon and associated interactive operational pattern to enable retrieval of weather forecast information related to “East Area in Kanagawa Prefecture” and the new registered recognition message word “Traffic Snarl”, its icon and associated interactive operational pattern to enable retrieval of traffic snarl information related to “Tomei Yokohama Machida and Tomei Kawasaki Area” from the base station for display.

FIG. 10 shows an example of a screen 100, of the display 3, which shows at its lower portion the icon 100a with the newly registered message word “News”, the icon 100b with the message word “Weather Forecast” and the icon 100c with “Traffic Snarl”.

In order to execute voice recognition operation in an actual practice, when the recognition message word “News” has been uttered by the user, the signal processor 9 of the client computer 20 produces synthesized voice to broadcast the message word “News” over the speaker 5 while displaying the icon “News” on the screen of the display 3. With such a display, the user is able to visually and verbally check whether or not the uttered word is correctly recognized in the client computer 20.

### ALTERED MODIFICATION OF FIRST PREFERRED EMBODIMENT

In the aforementioned first preferred embodiment and the modified form thereof, although the voice recognition operation system has been described with reference to an example wherein the word registering process at the base station is performed with the signal processor 12 and the word database 13, the word registering process may be executed with the use of the server computer 22 at the base station 110 by an operator and registered results may be transmitted to the client computer 20 via the telephone 11 and the network 24. In this case, the verbal communication, shown in FIG. 2, is performed between the user of the client computer 20 and the operator of the server computer 22 such that registered data involving newly registered word set, its icon and correlated control pattern is edited by the operator and transmitted back to the client computer 20 again.

### SECOND PREFERRED EMBODIMENT

In the aforementioned first preferred embodiment and the modified form thereof, since it is hardly to locate the large scale word database 13, which stores the control patterns and word information to be used for communication with the user, at the side of the client computer 20, the voice recognition operation system is arranged such that the word database 13 is located at the side of the server computer and communication between the user and the server computer 22 is performed via the network such as the Internet to newly register the words to be used for voice recognition control. Since, however, when applying the present invention to an automatic telephone dialing system responsive to voice recognition operation, a simple work is required for the user to merely register receiver's names and associated telephone numbers listed up in the user's telephone director, it is possible for the client computer to perform registration of particular verbal inputs and interacting operational patterns at only the user's side.

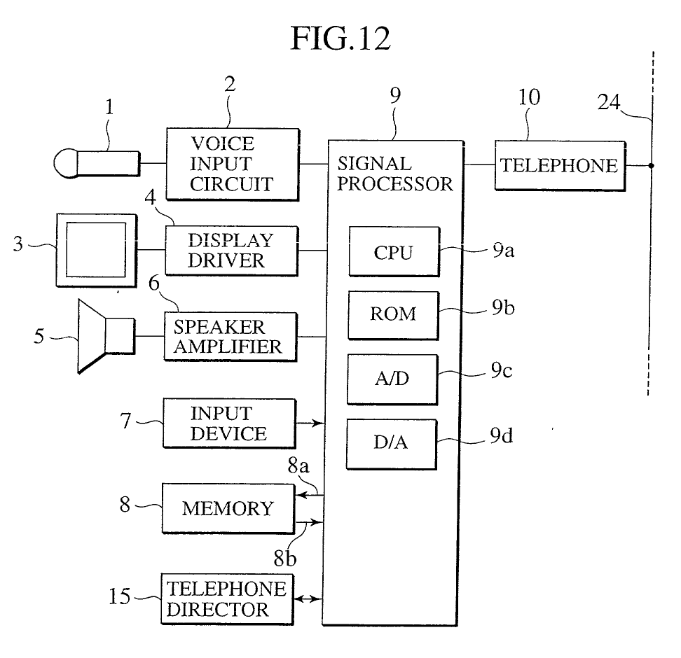

FIG. 12 shows a block diagram of the voice recognition operation system of the second preferred embodiment according to the present invention to achieve the above concept, with like parts bearing the same reference numerals as those used in FIG. 2 and the detailed description of the same parts being herein omitted for the sake of simplicity. The input device 7 includes a keyboard for inputting telephone numbers and manually actuatable control switches for enhancing programming and querying operations. In the second illustrated embodiment, the voice recognition operation system further includes a personally prepared telephone director 15 which stores receiver's information such as names, addresses and associated telephone numbers.

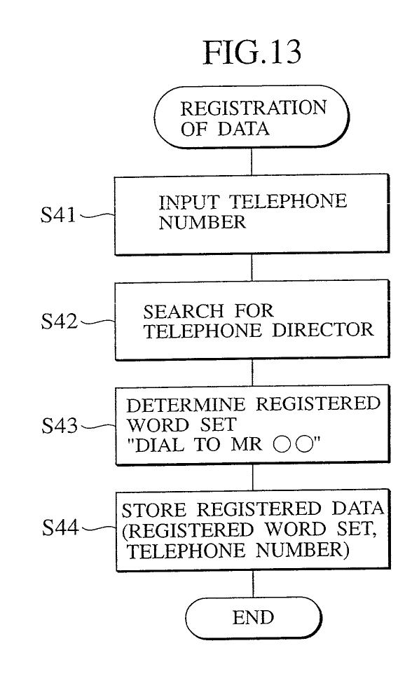

FIG. 13 is a general flow diagram for illustrating the various process steps of a registering process for the receiver's name and associated telephone numbers to be automatically dialed in the voice recognition operation. When the manual switch of the input device 7 for the start of registering operation is actuated, the signal processor 9 begins to perform registering operation process. In step S41, receiver's information is inputted to the signal processor 9 of the client computer 20 by operating the keyboard so as to input telephone numbers and associated data. In step S42, the telephone director 15 is searched to retrieve registered names and associated addresses correlated with the respective registered telephone numbers. In step S43, user determines the word command (registered word command) “Dial to Mr. OO” to be registered, and the signal processor 9 displays the registered word command “Dial to Mr. OO” and associated telephone number over the display monitor 3, while storing registered data such as the registered word command and the telephone number.

As noted above, when the manual switch of the input device 7 is actuated to select the mode for newly registering the word command to be used for voice recognition operation, the new word command and the interacting particular operational pattern to be used for voice recognition control on the basis of the particular telephone number inputted through the keyboard of the input device are registered in the client computer 20. With such a programming, mere input operation of the telephone number enables the word command and interacting operational pattern to be preset in the signal processor 9.

Further, in the event that if the new registered recognition word set resembles the other registered recognition word set which has been previously stored in the memory 8, it is advisable to determine the registered word by adding the receiver's address to the previously registered recognition word set like “Dial to Mr. OO at Yokohama”. Furthermore, a plurality of registered recognition word sets may be prepared in various combinations of the receiver's names and addresses, and prepared data may be displayed over the display 3 for user's selection.

When dialing the telephone number using voice recognition operation, the presence of uttered word command “Dial to Mr. OO” enables the signal processor 9 to search the registered recognition word sets stored in the memory 8 to select a pertinent registered recognition word set with the highest degree of word matching and to retrieve the interacting telephone number associated with the selected registered recognition word set to perform automatic dialing of the telephone to the receiver.

Also, in a case where the voice recognition operation system of the second preferred embodiment is installed on a vehicle, if the verbal input collected by the microphone 1 exceeds an average level by a give value, representing the start-up of the voice recognition operation system, it is preferred that the volume of an audio unit of the vehicle is automatically turned down to prevent erroneous operation of the voice recognition operation system.

The entire content of a Japanese Application No. P2000-312076 with a filing date of Oct. 12, 2000 is herein incorporated by reference.

Although the invention has been described above by reference to certain embodiments of the present invention, the invention is not limited to the embodiments described above and will occur to those skilled in the art, in light of the teachings. The scope of the invention is defined with reference to the following claims.

What is claimed is:

1. A voice recognition operation system, comprising:
a verbal input providing section providing a verbal input;
a memory storing a number of recognition word sets and interactive operational patterns to be used for voice recognition operational purposes;
a searching section searching a recognition word set, which has the highest matching degree with the verbal input, from the memory;
an output providing section providing an output of interactive operation patterns correlated with the searched recognition word set;
a new registration mode setting device setting a new registering mode to allow a particular recognition word set to be newly registered in the memory for use in another interactive operational pattern;
an input device inputting various information to the memory;
a setting section setting the newly registered recognition word set and interactive operational pattern on the basis of information inputted by the input device in the presence of the new registering mode; and
a registering section registering resultant data, obtained by the setting section, in the memory.

2. The voice recognition operation system according to claim 1, wherein
the input device includes the verbal input providing section; and
the setting section serves to allocate the interactive operational pattern to the verbal input which is inputted by the verbal input providing section.

3. The voice recognition operation system according to claim 1, wherein
the input device includes a keyboard; and
the setting section serves to allocate the interactive operational pattern to the verbal input which is inputted by the verbal input providing section.

4. The voice recognition operation system according to claim 1, wherein
the searching section serves to search for the registered recognition word set word stored in the memory in the presence of the registering mode with higher priority than a previously registered recognition word set stored in the memory.

5. The voice recognition operation system according to claim 1, further comprising:
a network communication unit to allow communication with a base station having a word database;
wherein the setting section is able to access the word database of the base station via the network communication unit for thereby setting the recognition word set and interactive operational pattern in the word database.

6. The voice recognition operation system according to claim 1, wherein
the setting section is able to set an icon to the recognition word set, which is newly registered in the new registering mode.

7. The voice recognition operation system according to claim 1, further comprising:
a display displaying the newly registered recognition word set and associated icon.

8. A voice recognition operation system, comprising:
means providing a verbal input;
means storing a number of recognition word sets and interactive operational patterns to be used for voice recognition operational purposes;
means searching a recognition word set, which has the highest matching degree with the verbal input, from the storing means;
means providing an output of interactive operation patterns correlated with the searched recognition word set;
means setting a new registering mode to allow a particular recognition word set to be newly registered in the storing means for use in another interactive operational pattern;
means inputting various information to the storing means;
means setting the newly registered recognition word set and interactive operational pattern on the basis of information inputted by the inputting means in the presence of the new registering mode; and
means registering resultant data, obtained by the setting means, in the storing means.

9. A method for operating a voice recognition operation system, comprising:
providing a verbal input;
storing a number of recognition word sets and interactive operational patterns, to be used for voice recognition operational purposes, in a memory;
searching a recognition word set, which has the highest matching degree with the verbal input, from the memory;
providing an output of interactive operation patterns correlated with the searched recognition word set;
setting a new registering mode to allow a particular recognition word set to be newly registered in the memory for use in another interactive operational pattern;
inputting various information to the memory;
setting the newly registered recognition word set and interactive operational pattern on the basis of information inputted by the inputting step in the presence of the new registering mode; and
registering resultant data, obtained in the setting step, in the memory.
